(19) United States
(12) Patent Application Publication
(10) Pub. No.: US 2002/0127990 A1
(43) Pub. Date: Sep. 12, 2002

(54) Method, apparatus and system for controlling the amplification of a high-frequency signal

(76) Inventor: Jan Bollenbeck, Muenchen (DE)

Correspondence Address: BELL, BOYD & LLOYD, LLC, P. O. BOX 1135, CHICAGO, IL, 60690-1135, US

(21) Appl. No.: 10/075,925

(22) Filed: Feb. 13, 2002

(30) Foreign Application Priority Data
Feb. 13, 2001 (DE) 101 06 616.3

(51) Int. Cl. H01Q 11/12

(52) U.S. Cl. 455/293; 455/127

(57) ABSTRACT

A method of controlling the amplification of a high-frequency signal, in particular an intermittent signal, in which a radio-frequency signal to be amplified is passed in a control loop to a variable-gain amplifier, the gain being controlled by an amplifier control signal, part of the amplified radio-frequency signal is coupled out via a directional coupler and passed to a power detector, the output voltage of which is passed for difference-forming with a control signal to inputs of a comparator circuit, the output voltage of which, as a gain control signal, is readjusted to increase the power output level, the readjustment continuing until the output voltage of the detector and the voltage of the control signal at the inputs of the comparator circuit compensate for one another.

### BACKGROUND OF THE INVENTION

Methods and units of the type mentioned are in use for the amplification of high-frequency signals not only in stationary applications but also in the area of mobile radio technology. In a compact and preferably highly integrated form of construction, they are consequently used, inter alia, in cordless telephones and mobile telephones (or cell phones) and their systems. Here, in the special case of processing in a TDMA mobile radio telephone (Time Division Multiple Access), a transmitted signal as a high-frequency signal must satisfy the system specification, according to which a predetermined variation over time of the transmission power output level must be maintained during an up and down adjustment of the transmitter. The up and down adjustment is referred to hereafter as up-ramping and down-ramping. Furthermore, an output level density spectrum of the signal has to be limited during the control process such that, outside an allotted time slot, no neighboring signals or other signals in neighboring frequency ranges are disturbed. Furthermore, for reliable data transmission, a mean value of the transmission power output level in the time slot or burst must be maintained essentially constantly.

To be able to adhere to the requirements dependent on temperature, variation in operating voltage, frequency and aging, a power output control is generally provided. Hardware control devices for power output control or power control are known from GSM devices (Global Standard for Mobile Communication). GSM in its original version operates with GMSK (Gaussian Minimum Shift Keying). Signals modulated in this way have a constant envelope curve. The detector voltage obtained via a power detector at the output of a transmitter amplifier is consequently a direct measure of the momentary transmission power output level and can be used as an actual value for a power output control. In the steady state, the momentary value of the power output within the transmission burst at every point in time corresponds to the mean-value power output.

EP 0 523 718 A2 discloses a device for pure power output control, which provides control via a table. This method requires an enormous adjustment effort and has a great memory space requirement, since the behavior of the transmitter amplifier in relation to frequency, operating voltage and temperature must be stored in look-up tables. However, possible influences of aging of the device can, nevertheless, be taken into account.

Also known is a method in which the amplitude modulation is applied separately from the phase modulation to the transmitted signal, known as the polar-loop transmitter. This may take place, for example, by modulation of the supply voltage of a power amplifier operating in a highly non-linear manner in C, D or E mode. In this case, the monitoring of the transmission power output level can take place in the same way. A disadvantage here, however, is the amount of circuitry, since two separate control loops have to be provided for amplitude and phase.

The present invention is, therefore, directed toward a method, a transmitting and/or receiving unit and a communication system which make improved setting of the transmission power output level possible with less circuitry and with a higher degree of flexibility for adaptation to different signal specifications.

### SUMMARY OF THE INVENTION

A circuit arrangement according to the present invention includes a control loop which, with the amplifier control signal kept constant, is opened via a switch; in particular, for the duration of a data transmission. In a time-division multiplex mode, this control loop can, in the closed state, follow a trapezoidal or ramp-shaped time-based waveform for adjusting the power output level of a high-frequency transmitted signal, known as ramping. However, the amplification of a control loop according to the present invention is then decoupled from a further variation of a momentary value of the power output level by opening of the switch and is operated in a hold mode with a constant gain factor.

If the transmitted signal is then subjected to an amplitude modulation, for example, there is no longer a relationship at every point in time between a momentary value of the power output level within the transmission burst and the mean-value power output, at least during a data transmission. On the basis of known prior-art methods and devices, modulation elements having frequencies which do not lie orders of magnitude above the bandwidth of the control loop for power output control are at least falsified or even corrected by a control system. Since the bandwidth of the control loop is determined by the ramping requirement, it is correspondingly not possible for it to be made as small as may be desired. Consequently, use of a conventional power output control system is not possible for signals of this type.

On the basis of a method according to the present invention, on the other hand, even these modulation elements are unaffected during the amplification since, in a basic form of the present invention, after the controlled UP-ramping, the value of the amplifier control voltage is sampled and stored via a sample-and-hold circuit shortly before the beginning of a data transmission, and the control loop is then opened. The circuit is in what is known as a hold mode. Since the amplifier control voltage does not change during the data transmission, the amplification of the adjustable amplifier also remains constant. By contrast with known devices, the gain factor is decoupled from a respectively momentary signal level, so that changes of the envelope curve or of the mean value of the signal can no longer have an effect. Consequently, the amplitude modulation of the signal also remains uninfluenced during the amplification.

To be able to increase the possible data rate of a mobile radio link with an unchanged claimed bandwidth, however, modulation methods with a varying envelope curve are increasingly being used. For instance, for the future of GSM, the modulation method EDGE GSM (enhanced data rate for GSM evolution, 3π/8-shifted 8PSK) is planned. A major area of use of embodiments of the present invention is accordingly to be seen here.

Preferably, in a method according to the present invention, the deviation between an amplifier control signal sampled and held by storage and a predetermined amplifier control signal is corrected during the “hold” mode. For this purpose, in the control loop, a second control loop is closed in the “hold” mode in such a way that the output voltage of the comparator circuit is kept at the stored value of the amplifier control signal. Deviations are corrected in each operating mode.

In an embodiment of the present invention, a difference between an amplification held in the control loop and a predetermined setpoint amplification of the control loop is corrected, so that undesired control processes do not occur within the control loop when switching back from the “hold” mode into a control mode with a controlled power output reduction. By sampling the actual amplification via an amplifier control signal shortly before the switchover from the “hold” mode into the control mode, a difference is determined, which is subtracted from the actual control signal for the duration of the down adjustment or down-ramping. Apart from lessening a tendency of the control loop to oscillate and suppressing interference frequencies and/or interferences of neighboring logical channels, a saving of energy is also brought about in this way by a generally faster falling power output curve.

The time pattern which causes the resolution of the necessary control signals is advantageously predetermined by the respective signal standard. For instance, these signals may be generated in a dedicated logic circuit after a one-off setting of the corresponding standard, whereby the method described above with all its developments can be used as a pure hardware solution for all known signal standards and also those currently only at the planning stage. Moreover, using standard components, a solution according to the present invention is also suitable for use in a highly integrated circuit.

Additional features and advantages of the present invention are described in, and will be apparent from, the following Detailed Description of the Invention and the Figures.

### BRIEF DESCRIPTION OF THE FIGURES

FIG. 1 shows a simplified block diagram for implementing a known power output control.

FIG. 2 shows a simplified block diagram of a first embodiment according to the present invention.

FIG. 3 shows a block diagram of a second embodiment of the present invention.

FIG. 4 represents a diagram to illustrate the variation of a power output curve over time as a “Power Time Template” for different control variants.

FIG. 5 shows a block diagram of a development of the present invention for an arrangement insensitive in its response to variations of the amplification.

### DETAILED DESCRIPTION OF THE INVENTION

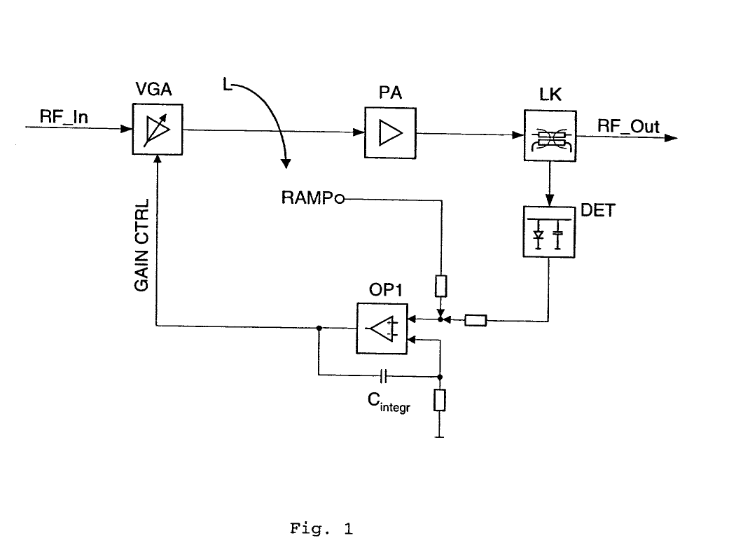

In the case of the circuit of FIG. 1, the basic function of a power output control in a control loop L known per se is represented. The radio-frequency signal to be amplified is passed via an input RF_In to a variable-gain amplifier VGA. The gain of the amplifier VGA is a function of an amplifier control signal GAIN CTRL. The following linear amplifier PA has a constant gain, to allow it to have a dynamic range which is as great as possible at an output RF_Out of the control loop L.

Part of the advance transmission power is decoupled via a directional coupler LK and passed to a power detector DET. The coupler LK has a constant coupling factor of, for example, −15 dB. With increasing power output, the detector DET supplies a negative voltage, which increases in terms of its absolute amount. If a positive control voltage RAMP is applied to a control input as a reference variable for a prescribed shape of a variation over time of the output power level, the potential at a non-inverting input of an operational amplifier OP1 increases. The operational amplifier OP1, operating as an integral-action controller, will increase its output voltage and, consequently, the transmission power output, until the detector output voltage, negatively increasing due to the growing output power, and the control voltage RAMP of the amplifier at the non-inverting input of the operational amplifier OP1 compensate for one another.

If the input power falls, the power coupled out via the directional coupler LK will also fall. Consequently, the negative detector output voltage will become smaller in its absolute amount. A positive differential voltage is produced at the inputs of the operational amplifier OP1. The output voltage of the operational amplifier OP1 increases, whereby the gain of the VGA increases. This control process continues until the setpoint output power is reached. This constitutes reaching a steady state in which the output voltage of the detector DET and the control voltage RAMP at the non-inverting input of the operational amplifier OP1 add together to give zero.

A corresponding situation also applies, however, to an amplitude modulation superposed on the input signal, provided that the lowest modulation frequency occurring falls into the bandwidth of the loop control, known as the loop bandwidth. The loop bandwidth must, however, be adapted to the requirements of the up and down adjustment of the power output level, that is to a variation over time of the power output level during the up-ramping and down-ramping. The loop bandwidth consequently cannot be made as small as may be desired, since the output power could otherwise not follow the control signal RAMP. Consequently, level changes of the input signal are greatly changed or even corrected. Thus, the power output control shown here is not suitable, in particular, for EDGE GSM, since it would, from the principle alone, significantly falsify the amplitude modulation element of the input signal. The amplified radio-frequency signal would be unusable.

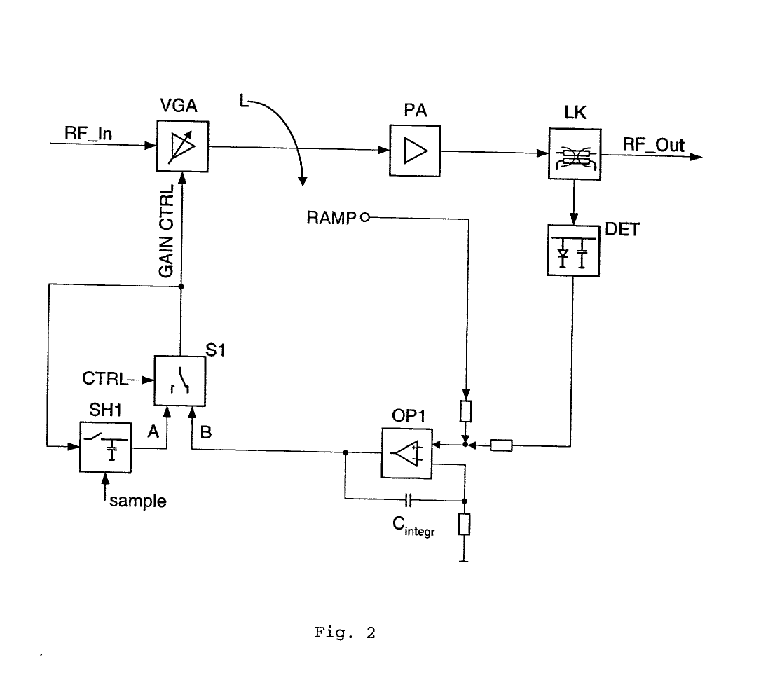

With the embodiment of an arrangement according to the present invention represented in FIG. 2, on the basis of the circuit of FIG. 1, the transmission power output level of a mobile radio telephone can be brought in a controlled manner to its value desired during the up-ramping and the control voltage of the amplifier VGA can be kept constant during the period of the data transmission DATA by a sample-and-hold circuit SH1. For this purpose, after triggering of a sampling of the control voltage by a signal sample, a switch S1 is brought from a switching position B into a switching position A by a control signal CTRL. Consequently, the sampled signal lies at the output of the switch S1 for as long as the control signal CTRL is set. The control loop L is open during this period, so that a varying mean value of the radio-frequency signal to be amplified also cannot exert any influence on the amplification via the operational amplifier OP1.

Shortly before the lowering of the transmission power output level, after completion of a data transmission, the switch S1 is reset again into the switching position B by the control signal CTRL. In this switching position, the circuit of FIG. 2 corresponds again in its function to the circuit of FIG. 1. Consequently, the subsequent down-ramping in the closed control loop L proceeds again in a control mode following the control signal RAMP.

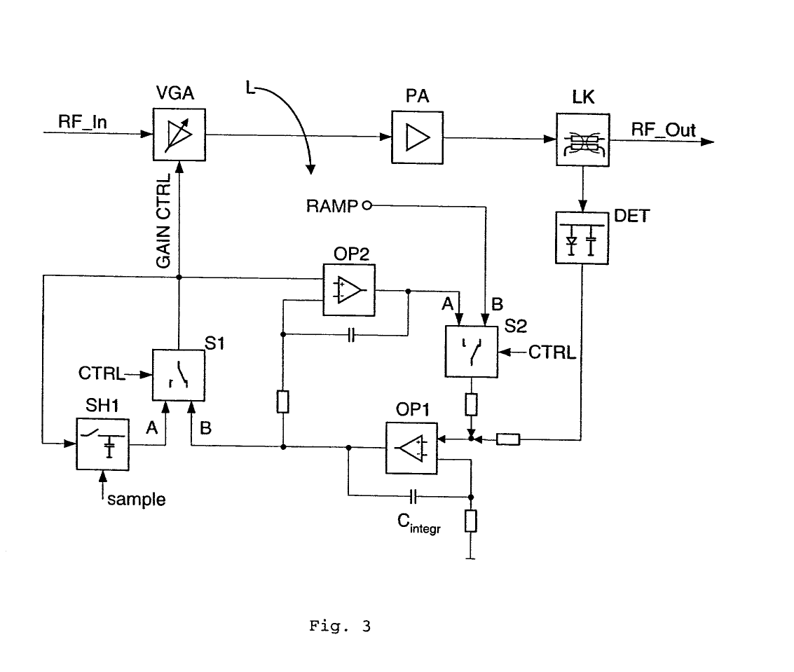

In the circuit of FIG. 3, a further control loop has been inserted in comparison with that of FIG. 2. An operational amplifier OP2, likewise operating as an integral-action controller, compares the output signal of the operational amplifier OP1 with the amplifier control signal GAIN CTRL. Switching back and forth between the two operating modes “control” and “hold” is continued via the changeover switch S1. However, it is now ensured by the special design of the circuit that, before switching back into the control mode, the inputs and outputs of the control operational amplifier OP1 already have during the down-ramping the potentials obtained in the steady state with the mean-value power output. In an ideal case, using fast changeover switches, consequently no transient phenomena occur with switching over from “hold” to “control”. For this purpose, the output signal of the operational amplifier OP2 is added to the output signal of the power detector DET at the input of the operational amplifier OP1, so as to correct a deviation between the output signal of the operational amplifier OP1 and the amplifier control signal GAIN CTRL. In the switching position B, the inputs of the operational amplifier OP2 are virtually equal in potential as a result of switching compulsion, so that an output signal of the operational amplifier OP2 could only cause disturbances at the input of the operational amplifier OP1. Therefore, a further switch S2 is provided, which disconnects the second control loop in the switching position B of the switches S1, S2. In an ideal case, the switches S1, S2 are switched by the control signal CTRL at the same time and essentially without any delay.

The control process via the second control loop, described above, consequently intervenes actively only in the switching position A of the switches S1, S2 and then has the effect that any difference between the output signal of the operational amplifier OP1 and the amplifier control signal GAIN CTRL is corrected. Consequently, in particular with switching over switch S1, no differences in potential occur between the inputs of the switch S1 and its output. If, after the data transmission, switching back into the controlled mode takes place, no transient phenomena occur, since all the switched interfaces already have the correct potentials and the integration capacitor C_{integr} is correctly charged. The control is held in a virtual “steady state” during the “hold” mode. The switching-over consequently proceeds in a monitored manner and without control processes or even oscillations of the control loop L. Transient phenomena during switching over would, by contrast, be manifested adversely both in the variation over time of the transmission power output level and also in the transient spectrum as an infringement of a specification of the transmitting unit.

A circuit of this type also can be constructed according to the present invention as a modification of a circuit described in DE 199 49 182 A1 for a CDMA modulation method (Code Division Multiple Access) with reference to the illustration of FIG. 1 therein. The circuit disclosed in the publication likewise has a closed control loop with a second control loop. In this case, the second control loop again essentially includes only an operational amplifier which is connected or disconnected via two switches. According to the present invention, this circuit would be modified for use in a transmitter with a TDMA modulation method in such a way that the operational amplifier would operate as an integral-action controller. Furthermore, the outputs and inputs of the control loop would be used with an analog/digital converter ADC, a logic circuit or a look-up memory and a digital/analog converter DAC in the function of a sample-and-hold circuit SH1. However, from the aspect of circuitry, a solution according to the present invention as represented by FIG. 3 is to be preferred. Nevertheless, reference is expressly made at this point to the aforementioned publication, in particular with regard to the measures for temperature compensation. The developments, such as for example an arrangement of a temperature compensation diode in close thermal coupling with a detector diode of the power detector DET by arrangement in a common housing, and therefore the same physical behavior, also can be used with the same advantages in a circuit according to the present invention.

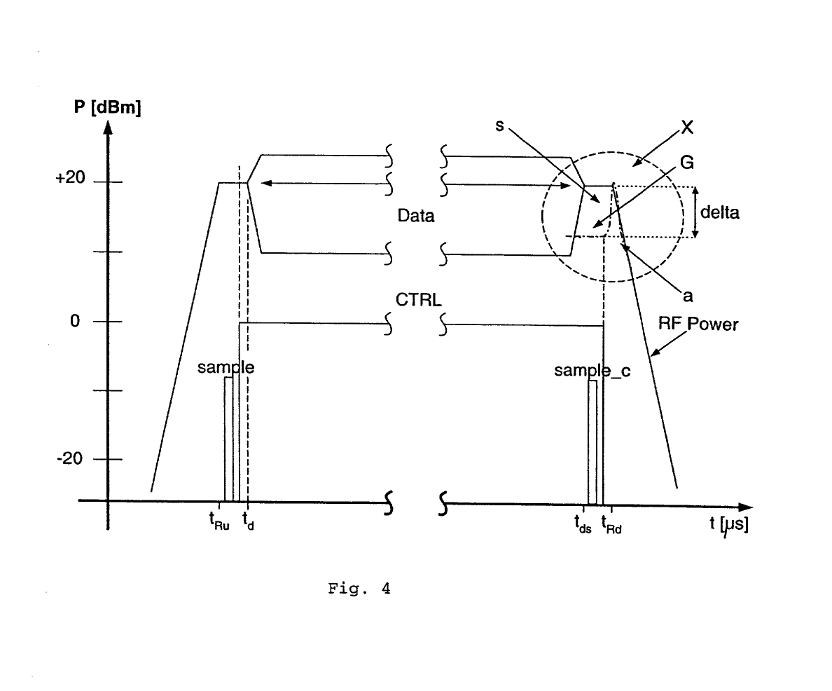

A diagram with a sketched representation of the variation of a power output curve RF Power over time is shown in FIG. 4. In preparation for data transmission, the transmission power output level is ramped up from a disconnected state to a point in time t_{Ru}, to then be kept at a constant value of, for example, +20 dBm. In a time period between the point in time t_{Ru} and the beginning of the phase DATA with a data transmission at the point in time t_{d}, the control signal sample is set for sampling the amplifier control signal GAIN CTRL. Even before the point in time t_{d}, the control signal CTRL is set, in order to open the control loop L with a constant value of the amplifier control signal GAIN CTRL.

Since the output voltage of the detector DET varies, seen over time, due to the amplitude modulation of the data signal, the output voltage of the operational amplifier OP2 also changes over time. The control wants to compensate for the detector voltage change at the non-inverting input of the operational amplifier OP1. The control therefore must be dimensioned such that, after data transmission has taken place, it reaches a steady state after a point in time t_{ds} and still before resetting of the control signal CTRL for the switches S1, S2. It is also possible, but not necessary, for the control to be designed to be so fast that it can always follow the amplitude modulation.

If the amplification of the amplifier series including VGA and PA does not change during a burst, which may occur, for example, due to heating, at this point in time the output voltage of the OP2 corresponds to the last-present control voltage RAMP. No transient phenomena or other control processes occur during switching back from the “hold” mode into the control mode.

If, however, the amplification of the amplifier series including VGA and PA does change over a burst period DATA, for example due to heating of the PA, an undesired control process will occur during switching back from the “hold” mode into the control mode if there is no suitable countermeasure, since the output power and consequently also the output voltage of the operational amplifier OP2 have changed over the burst. With a falling output power, the detector output voltage, which is negative here, increases. The arrangement counteracts the cause and will make the output voltage of the operational amplifier OP1 keep increasing until the output voltage of the operational amplifier OP2 and the detector output voltage again compensate for one another at the non-inverting input of the operational amplifier OP1. Although the output voltage of the operational amplifier OP1 is equal to the GAIN CTRL voltage, the output voltage of the operational amplifier OP2 then no longer corresponds, however, to the control voltage RAMP at the points in time of the end of up-ramping and the beginning of down-ramping. The control loop L responds after the switching-over to the voltage jump of the reference variable, the output voltage of changeover switch S1. This case is sketched in the region X of FIG. 4. Here, a power drop G of a variable delta is answered by the control loop L by an abrupt increase in the output power, virtually a step change, along a curve branch s. In this case, the control loop L even oscillates slightly.

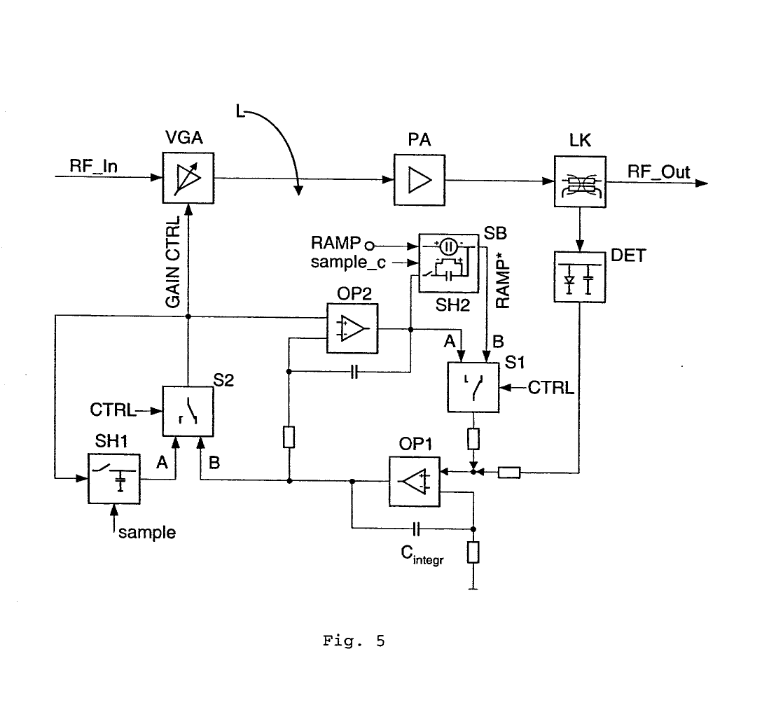

As a solution to this problem and as a development of the circuit of FIG. 3, the circuit of FIG. 5 represents an arrangement which is insensitive in its response to variations of the amplification. A second sample-and-hold circuit SH2 allows the difference between the control voltage RAMP and the OP2 output voltage to be sampled shortly before the switching-back from “hold” to control. This sampling is controlled by a control signal sample_c, which is included in the sketch of FIG. 5 to represent a time sequence. After the switching-over of the switches S1, S2 to switching position B, this difference is added to the control voltage RAMP. In this case, the difference is normally negative, since the amplification decreases with increasing temperature. The resulting voltage then corresponds to the voltage last present at the output of the operational amplifier OP2. The down-ramping begins at a point in time t_{Rd} on the existing fallen power output level, and the power curve RF Power proceeds from the power level lowered from the setpoint amount by the amount delta through the range a without additional control processes, oscillations or the like in the direction of the falling flank of the power output curve RF Power.

The internal wiring of a circuit block SB which has correspondingly been newly inserted in the circuit of FIG. 5 is based on a simulation and includes a voltage-controlled voltage source and the sample-and-hold circuit SH2. The sample-and-hold circuit SH2 samples a possible voltage difference at a point in time shortly before the switching-over from “hold” mode into control mode under the control of the signal sample_c. Before this process, the voltage source has the voltage zero and can, therefore, be thought of as a short-circuit. Consequently, at this point in time the control voltage RAMP is present at the negative terminal of the voltage source, the output of block SB. After the sampling process, the voltage source assumes the value of the voltage difference stored in the sample-and-hold circuit SH2. This voltage is then added on to the control voltage RAMP, since the voltage source lies in series with the control voltage RAMP. This results in a corrected controlled variable RAMP*, so that, after the switching-over of the switch S2, again no change in potential occurs. Correspondingly, no control processes are initiated. Before the first UP-ramping, the value of the voltage source is again set to zero.

In the respective embodiments of the present invention, the control signals CTRL, sample, sample c_and RAMP are preferably generated in a control part (not represented here) of the mobile radio telephone. They are determined by a prescribed time pattern of a chosen mobile radio standard.

With a circuit according to the present invention, a monitored ramping of amplitude-modulated transmitted signals or bursts to a defined power output level is also possible, without an amplitude modulation in the burst being influenced during a phase of the data transmission. Consequently, signals with any desired low-frequency amplitude modulation elements can be used or amplified. Furthermore, signals of any desired burst length can be used. The minimum length is determined by the control time constants of the control loop.

Control processes during switching-back from the hold mode into the control mode are advantageously also largely prevented. By extending the circuit corresponding to the illustration of FIG. 5, a power drop due to heating in the amplifier chain including VGA and/or PA, etc., during a burst then also does not cause any undesired control processes. The control signals necessary for the sample-and-hold circuits, CTRL, sample, sample_c, are coupled to the time pattern used and therefore also can be derived from a single trigger signal and/or a respective data signal standard. A simple logic circuit can be provided for this purpose.

When putting a method according to the present invention into practice, the known advantages of a hardware power output control system can be utilized; that is, in particular, a low adjustment effort, good temperature compensation, low frequency dependence and virtually no aging. Consequently, a device according to the present invention preferably represents a pure hardware solution and can be used as a “stand-alone” circuit. Furthermore, a circuit according to the present invention can be used independently of the chip set and the software of a system. The arrangement can, moreover, be achieved as an inexpensive and space-saving ASIC solution or be integrated as a pre-designed finished subassembly in a chip.

Due to the suppression of control processes and oscillations of the control loop, a circuit according to the present invention also adheres to very strict specifications of the variation over time and frequency of the output signal, it being possible for it to be freely adapted in wide ranges to diverse TDMA signal standards. Together with the suitability, in principle, for energy-saving and highly integrated circuits, use in mobile terminal equipment or transmitting and/or receiving units of a data transmission device or a communication system or mobile telephones is preferred for a circuit according to the present invention. However, this does not exclude advantageous use in other applications for amplifying higher-frequency and/or high-frequency signals.

Indeed, although the present invention has been described with reference to specific embodiments, those of skill in the art will recognize that changes may be made thereto without departing from the spirit and scope of the invention as set forth in the hereafter appended claims.

1. A method for controlling amplification of a high-frequency intermittent signal, the method comprising the steps of:
passing a radio-frequency signal to be amplified in a controlled loop to a variable-gain amplifier, a gain being controlled by an amplifier control signal;
coupling out part of the amplified radio-frequency signal via a directional coupler;
passing the coupled out part of the amplified radio-frequency signal to a power detector;
passing an output voltage of the power detector for difference-forming with a separate control signal to inputs of a comparator circuit;
readjusting an output of the comparator circuit, as the amplifier control signal, to increase a power output level;
continuing the readjustment until the output voltage of the detector and a voltage of the separate control signal at the inputs of the comparator circuit compensate for one another; and
opening the control loop and keeping the amplifier control signal constant for a duration of a data transmission.

2. A method for controlling amplification of a high-frequency intermittent signal as claimed in claim 1, the method further comprising the step of:
making a switchover into a hold mode, after a controlled up-ramping of a power output level of the radio-frequency signal to be amplified, with the gain kept constant.

3. A method for controlling amplification of a high-frequency intermittent signal as claimed in claim 1, the method further comprising the step of:
storing the amplifier control signal for constant setting in a sample-and-hold circuit before beginning the data transmission.

4. A method for controlling amplification of a high-frequency intermittent signal as claimed in claim 2, the method further comprising the step of:
making a switchover into a control mode, after the hold mode with a gain kept constant, for the controlled up-ramping of the power output level of the radio-frequency signal to be amplified.

5. A method for controlling amplification of a high-frequency intermittent signal as claimed in claim 4, wherein switching is performed back and forth between the hold and the control modes.

6. A method for controlling amplification of a high-frequency intermittent signal as claimed in claim 4, wherein the switching over from the control mode to the hold mode occurs before the data transmission and switching back from the hold mode to the control mode occurs after the data transmission.

7. A method for controlling amplification of a high-frequency intermittent signal as claimed in claim 2, the method further comprising the step of:
closing a second control loop, during the hold mode in the control loop, such that the output voltage of the comparator circuit is kept at the stored value of the amplifier control signal.

8. A method for controlling amplification of a high-frequency intermittent signal as claimed in claim 7, the method further comprising the step of:
correcting a deviation between the output voltage of the comparator circuit and the stored value of the amplifier control signal by an additional operational amplifier in the second control loop.

9. A method for controlling amplification of a high-frequency intermittent signal as claimed in claim 8, the method further comprising the step of:
correcting a deviation between an output voltage of the additional operational amplifier and the separate control signal so as to avoid control processes of the control loop due to a possible power drop.

10. A method for controlling amplification of a high-frequency intermittent signal as claimed in claim 9, wherein the correction is performed after a phase of the data transmission.

11. A method for controlling amplification of a high-frequency intermittent signal as claimed in claim 9, wherein the deviation between an output voltage of the additional operational amplifier and the separate control signal is established by a sampling operation shortly before a point in time which is one of a start of a down-ramping and a controlled power output reduction.

12. A method for controlling amplification of a high-frequency intermittent signal as claimed in claim 9, wherein the deviation between the output voltage of the operational amplifier and the separate control signal is held in a sample-and-hold circuit and subtracted from the separate control signal to form a new control signal.

13. A method for controlling amplification of a high-frequency intermittent signal as claimed in claim 9, wherein switches are switched by a switch control signal at a same time and substantially without delay.

14. A method for controlling amplification of a high-frequency intermittent signal as claimed in claim 1, the method further comprising the steps of:
simulating a variation over time of the power output level during one of up-ramping and down-ramping by the separate control signal; and
predetermining a respectively desired power output level.

15. A method for controlling amplification of a high-frequency intermittent signal as claimed in claim 1, wherein the separate control signal and the switch control signal are generated in a control part.

16. A method for controlling amplification of a high-frequency intermittent signal as claimed in claim 15, wherein the separate control signal and the switch control signal are generated in the control part based on a predetermined time pattern of a respective mobile radio standard.

17. A unit for at least one of transmitting and receiving, and for controlling amplification of a high-frequency intermittent signal, comprising:
a control loop for controlling a power output level of a high-frequency signal to be amplified;
a variable gain amplifier in the control loop, an input being connected to the variable gain amplifier and a gain of the variable gain amplifier being formed such that it can be controlled via an amplifier control signal;
a directional coupler in the control loop, the directional coupler for coupling out part of the output power of the amplified high-frequency signal;
a power detector provided at an output of the control loop, the power detector receiving from the directional coupler the coupled out part of the output power of the amplified high-frequency signal; and
a comparator circuit connected to the power detector for receiving an output voltage of the power detector, the comparator circuit determining a difference between a separate control signal connected to the comparator circuit and the output voltage of the detector, the comparator circuit correcting the difference via an adaptation of the amplifier control signal as an output signal of the comparator circuit, wherein provisions are made to open the control loop and keep the amplifier control signal constant for a duration of a data transmission.

18. A unit for at least one of transmitting and receiving, and for controlling amplification of a high-frequency intermittent signal as claimed in claim 17, further comprising a switch for opening and closing the control loop via a switch control signal for interrupting the control loop.

19. A unit for at least one of transmitting and receiving, and for controlling amplification of a high-frequency intermittent signal as claimed in claim 18, further comprising a sample-and-hold circuit in the control loop for keeping the amplifier control signal constant.

20. A unit for at least one of transmitting and receiving, and for controlling amplification of a high-frequency intermittent signal as claimed in claim 19, wherein the switch connects the sample-and-hold circuit when the control loop opens.

21. A unit for at least one of transmitting and receiving, and for controlling amplification of a high-frequency intermittent signal as claimed in claim 17, wherein the comparator circuit is an operational amplifier designed as an integral-action controller.

22. A unit for at least one of transmitting and receiving, and for controlling amplification of a high-frequency intermittent signal as claimed in claim 17, further comprising a linear amplifier with a constant gain factor following the variable gain amplifier for further amplification of the radio-frequency signal to be amplified.

23. A unit for at least one of transmitting and receiving, and for controlling amplification of a high-frequency intermittent signal as claimed in claim 17, wherein the directional coupler has a constant coupling factor of −15 dB.

24. A unit for at least one of transmitting and receiving, and for controlling amplification of a high-frequency intermittent signal as claimed in claim 17, further comprising a second control loop for correcting a deviation between the output signal of the comparator circuit and a stored value of the amplifier control signal.

25. A unit for at least one of transmitting and receiving, and for controlling amplification of a high-frequency intermittent signal as claimed in claim 24, further comprising a further operational amplifier with an integrating property in the second control loop.

26. A unit for at least one of transmitting and receiving, and for controlling amplification of a high-frequency intermittent signal as claimed in claim 25, further comprising a device for correcting a deviation between the separate control signal and an output signal of the second control loop.

27. A unit for at least one of transmitting and receiving, and for controlling amplification of a high-frequency intermittent signal as claimed in claim 26, further comprising means for correcting a difference between a gain held in the control loop and a predetermined set point gain of the control loop, wherein undesired control processes do not occur within the control loop when switching from a hold mode into a control mode.

28. A unit for at least one of transmitting and receiving, and for controlling amplification of a high-frequency intermittent signal as claimed in claim 27, wherein the means for correcting includes a sample-and-hold circuit for sampling an output signal of the further operational amplifier.

29. A unit for at least one of transmitting and receiving, and for controlling amplification of a high-frequency intermittent signal as claimed in claim 27, wherein the means for correcting includes a voltage-controlled voltage source for adapting the separate control signal, designed for generating an adapted control signal by subtraction of a difference, determined on the basis of a sampling operation.

30. A unit for at least one of transmitting and receiving, and for controlling amplification of a high-frequency intermittent signal as claimed in claim 18, further comprising a control part for generating the separate control signal and the switch control signal based on a prescribed time pattern of a respective mobile radio standard.

31. A unit for at least one of transmitting and receiving, and for controlling amplification of a high-frequency intermittent signal as claimed in claim 17, wherein the unit is contained in a mobile terminal of at least one of a cellular data network and a communication network.

32. A communication system with a transmitting unit and a receiving unit for exchanging data via an intermittent radio frequency signal, the system comprising:
a control loop for amplification of a high-frequency signal provided in the transmitting unit; and
means for interrupting the control loop and means for keeping an amplifier control signal constant over a certain time period provided in the control loop, the means for interrupting and the means for keeping designed for activation via control signals.

33. A communication system with a transmitting unit and a receiving unit for exchanging data via an intermittent radio-frequency signal as claimed in claim 32, wherein at least one of the transmitting unit and the receiving unit is configured as a mobile unit.

34. A communication system with a transmitting unit and a receiving unit for exchanging data via an intermittent radio-frequency signal as claimed in claim 34, wherein the mobile unit is at least one of a mobile telephone and a mobile data transmission device.
